(19) United States
(12) Patent Application Publication
(10) Pub. No.: US 2026/0280887 A1
(43) Pub. Date: Sep. 17, 2026

(54) ISSUING METHOD AND ISSUING SYSTEM

(71) Applicant: NTT DOCOMO, INC., Tokyo (JP)

(72) Inventors: Tetsuhiro Sasagawa, Chiyoda-ku, Tokyo (JP); Keita Kitagawa, Chiyoda-ku, Tokyo (JP); Yosuke lizuka, Chiyoda-ku, Tokyo (JP); Kenji Hashimoto, Chiyoda-ku, Tokyo (JP)

(73) Assignee: NTT DOCOMO, INC., Tokyo (JP)

(21) Appl. No.: 19/163,298

(22) PCT Filed: Mar. 13, 2023
(86) PCT No.: PCT/JP2023/009604

§ 371 Date: Sep. 8, 2025

(51) Int. Cl. H04L 9/32

(52) U.S. Cl. CPC H04L 9/3234

(57) ABSTRACT

An issuing method to issue a profile for connecting a terminal to a mobile communication network to be written in a module mounted to the terminal in a network device of a terminal operator manufacturing the terminal, comprises: a first output step in which the module outputs a first authentication token from an encryption key based on authentication logic; a second output step in which the network device outputs a second authentication token from the encryption key based on the authentication logic; a confirmation step in which the module confirms whether the first authentication token and the second authentication token are the same; and an issuing step in which the network device issues the profile when the network device confirms that the first authentication token and the second authentication token are the same.

### TECHNICAL FIELD

The present disclosure relates to an issuing method and an issuing system to issue a profile for connecting to a mobile communication network, for a module mounted to a terminal.

### BACKGROUND ART

An embedded SIM (eSIM) mounted to a terminal is known as a Subscriber Identity Module (SIM) capable of rewriting in software a profile, such as subscriber information (International Mobile Subscriber Identity, IMSI), for connecting to a mobile communication network (Patent Literature 1). Note that only a software configuration of an eSIM may be referred to as an eSIM. In this case, a hardware configuration, such as a card type integrated circuit (IC card, SIM card) to which an eSIM is written, may be referred to as an embedded Universal Integrated Circuit Card (eUICC).

An eSIM can store a plurality of pieces of subscriber information, and even if different pieces of subscriber information are used, physical replacement of SIM cards is not required. Specifically, among the plurality of pieces of subscriber information stored in an eSIM, a desired piece of subscriber information can be activated to use the subscriber information. The eSIM is recognized by a terminal/network (NW) as a SIM in which only an activated piece of subscriber information is written. If no piece of subscriber information is activated, the eSIM is recognized as a SIM in which no subscriber information is written.

### CITATION LIST

### Patent Literature

Patent Literature 1: Japanese Patent Application Publication No. 2016-046662

### SUMMARY OF INVENTION

A SIM profile to be written in an eSIM is issued at a factory manufacturing a terminal (hereinafter, also referred to as a terminal operator). Specifically, a SIM profile such as subscriber information is acquired via a Subscription Manager (SM) server in a network device of the terminal operator, and the acquired SIM profile is written in the eSIM mounted to the terminal. At this point, an issuance status of the SIM profile issued by the terminal operator is shifted to “issued.”

However, from the viewpoint of security, the SIM profile whose issuance status is shifted to “issued” cannot be reissued in a network device of the terminal operator. Therefore, there is a problem in that the SIM profile cannot be reissued even if the terminal is returned to the terminal operator due to a failure or the like.

Therefore, this disclosure has been made in view of such a situation, and an object of this disclosure is to provide an issuing method and an issuing system that can reissue a SIM profile in a network device of a terminal operator while ensuring security.

One aspect of the disclosure is an issuing method to issue a profile for connecting a terminal to a mobile communication network to be written in a module mounted to the terminal in a network device of a terminal operator manufacturing the terminal, comprising: a first output step in which the module outputs a first authentication token from an encryption key based on authentication logic; a second output step in which the network device outputs a second authentication token from the encryption key based on the authentication logic; a confirmation step in which the module confirms whether the first authentication token and the second authentication token are the same; and an issuing step in which the network device issues the profile when it is confirmed that the first authentication token and the second authentication token are the same.

One aspect of the disclosure is an issuing system to issue a profile for connecting a terminal to a mobile communication network to be written in a module mounted to the terminal, comprising: a network device of a terminal operator manufacturing the terminal; and the module mounted to the terminal; wherein the module outputs a first authentication token from an encryption key based on authentication logic; the network device outputs a second authentication token from the encryption key based on the authentication logic; the module confirms whether the first authentication token and the second authentication token are the same; and the network device issues the profile when it is confirmed that that the first authentication token and the second authentication token are the same.

### BRIEF DESCRIPTION OF DRAWINGS

FIG. 1 is an overall schematic configuration diagram of a SIM profile issuing system.

FIG. 2 is a functional block diagram of a network device.

FIG. 3 is a functional block diagram of a server.

FIG. 4 is a functional block diagram of a terminal.

FIG. 5 is a diagram illustrating an example of a SIM profile acquired from a server.

FIG. 6 is a sequence diagram illustrating a SIM profile issuance procedure by a terminal operator.

FIG. 7 is a sequence diagram illustrating a SIM profile reissuance procedure by a terminal operator.

FIG. 8 is a diagram illustrating an example of a hardware configuration of a network device, a server, and a terminal.

FIG. 9 is a diagram illustrating an example of a vehicle configuration.

### DESCRIPTION OF EMBODIMENTS

Embodiments will be described below based on the drawings. The same functions and configurations are denoted by the same or similar reference signs, and descriptions thereof will be omitted, as appropriate.

### (1) Overall Schematic Configuration of Issuing System

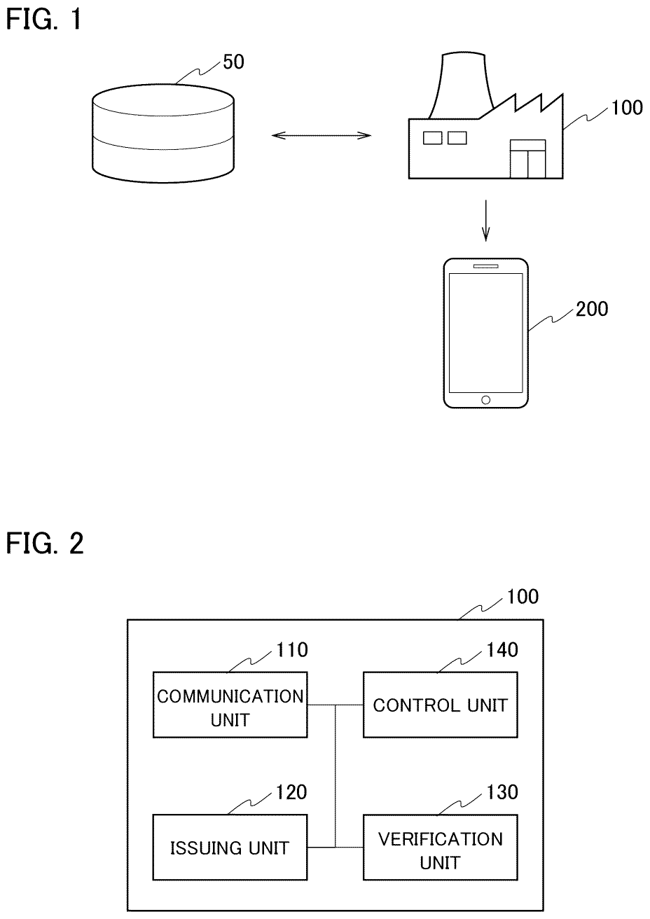

The issuing system illustrated in FIG. 1 includes a server 50, a network device 100 of a factory (hereinafter, terminal operator), and a terminal (User Equipment, UE) 200. The terminal operator may be interpreted as a manufacturer (terminal vendor) or manufacturing facility to manufacture the UE 200. The network device 100 may be interpreted as a part of a manufacturing facility of the UE 200, and may be interpreted as an issuing device to issue a SIM profile to the UE 200.

The network device 100 is connected to the server 50 and the UE 200 via a network (not illustrated). The network may include the Internet or a Virtual Private Network (VPN).

The network device 100 acquires a SIM profile including an IMSI or the like for connecting the UE 200 to a mobile communication network via the server 50, and issues the acquired SIM profile to the UE 200. The mobile communication network may include a radio access network (RAN). The RAN may correspond to communication systems called 4G, 5G, Beyond 5G, 5G Evolution, and 6G. The RAN may be an Evolved Universal Terrestrial Radio Network (E-UTRAN) or a Next Generation-Radio Access Network (NG-RAN).

The server 50 is an SM server that manages a SIM profile including an IMSI or the like for connecting the UE 200 to the mobile communication network, and provides the SIM profile to the UE 200 via the network device 100. The server 50 is, for example, Subscription Manager Data Preparation+(SM-DP+).

The UE 200 includes a module in which a SIM profile including an IMSI or the like for connecting to the mobile communication network is written. The module of the embodiment is an eSIM mounted to the UE 200. Generally, only the software configuration of the eSIM may be referred to as an eSIM. However, in the following, the software configuration written to a module is referred to as a SIM profile, and the module itself (hardware configuration) is referred to as an eUICC for the purpose of distinction. The module is not limited to a card-type IC such as an eUICC, but can be any IC.

### (2) Functional Block Configuration of Issuing System

### (2.1) Functional Block Configuration of Network Device

As illustrated in FIG. 2, the network device 100 includes a communication unit 110, an issuing unit 120, a verification unit 130, and a control unit 140.

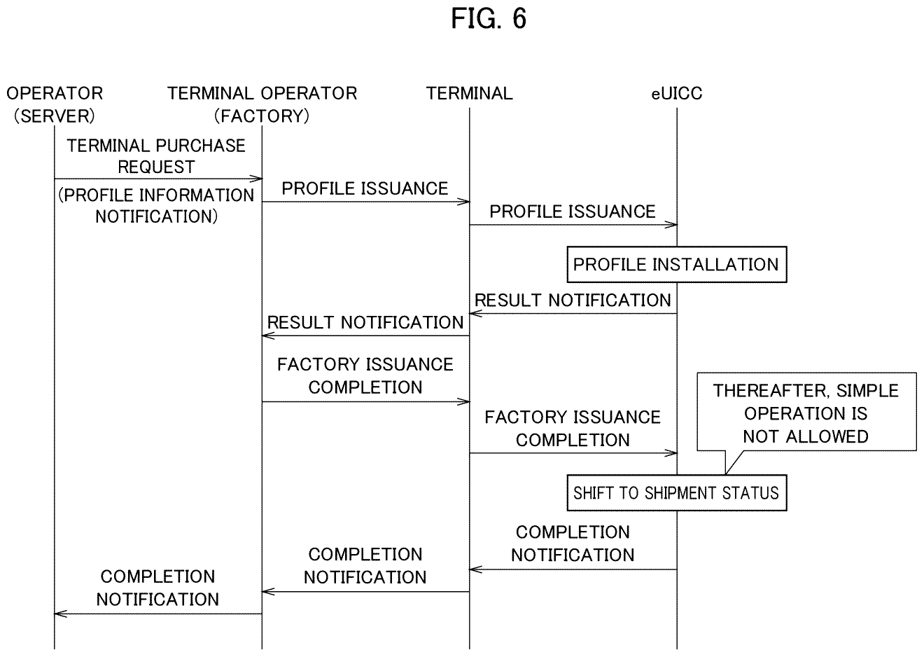

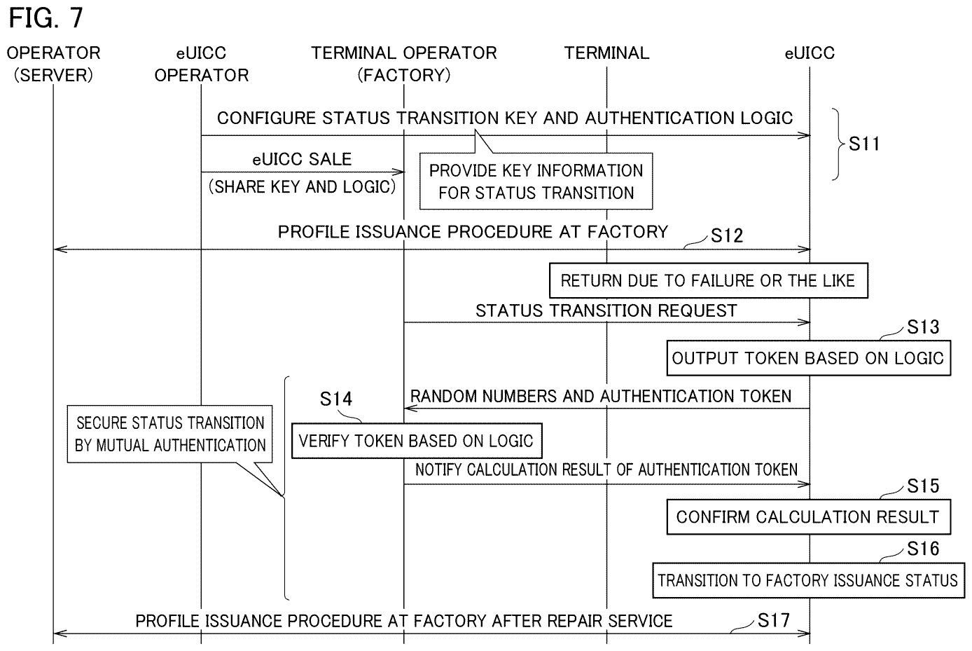

The communication unit 110 communicates with the server 50 and the UE 200 via the network described above. The communication unit 110 transmits and receives various notifications or information between the server 50 and the UE 200 as illustrated in FIGS. 6 and 7, which will be described below.

The issuing unit 120 issues a SIM profile to the UE 200. The issued SIM profile is transmitted to the UE 200 by the communication unit 110.

The verification unit 130 verifies an authentication token received from the UE 200 based on authentication logic and an encryption key obtained from an eUICC operator in advance (see FIG. 7).

The authentication logic is, for example, Authentication and Key Agreement (AKA) authentication. The authentication logic is not limited to mutual (bidirectional) authentication such as AKA authentication, but may be unidirectional authentication such as, for example, storing a password in advance in the eUICC and using the password. The authentication logic may be called an authentication algorithm, an authentication protocol, or the like. An encryption key is, for example, a common key used for symmetric encryption. The encryption key may be a key pair of a public key and a private key used for asymmetric encryption.

Verification of an authentication token may be interpreted as confirming whether the authentication token output from an encryption key based on the authentication logic is the same as the authentication token received from the UE 200.

Here, when random numbers are used in the authentication logic, it may be interpreted that the verification of the authentication token is to output an authentication token from an encryption key and random numbers. In this case, the random numbers used to output the authentication token may be received together with the authentication token from the UE 200.

Note that the authentication token may be interpreted as one of multiple calculation results output from the encryption key and random numbers based on the authentication logic. That is, the verification unit 130 may confirm whether one of the multiple calculation results output from the encryption key and random numbers based on the authentication logic is the same as the authentication token received from the UE 200.

The verification result (calculation result in the drawing) of the authentication token is transmitted to the UE 200 by the communication unit 110. Here, the verification result of the authentication token may be interpreted as the authentication token output from the verification unit 130, or may be interpreted as a determination result of whether the authentication token output from the verification unit 130 is the same as the authentication token received from the UE 200. When the authentication token output from the verification unit 130 is transmitted, the authentication token to be transmitted may be interpreted as a calculation result different from the authentication token received from the UE 200 among the multiple calculation results by the verification unit 130. In other words, among the calculation results output from the verification unit 130, the same calculation result as the one received from the UE 200 may be different from the calculation result transmitted to the UE 200.

The control unit 140 controls the network device 100. The control unit 140 controls, for example, the transmission and reception of notifications or information by the communication unit 110, the issuance of SIM profiles by the issuing unit 120, and the verification of authentication tokens by the verification unit 130.

### (2.2) Functional Block Configuration of Server

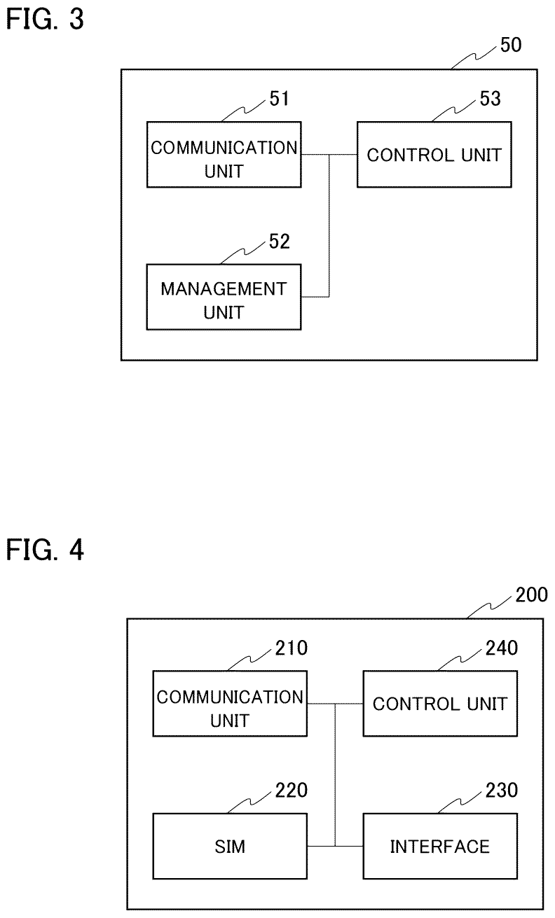

As illustrated in FIG. 3, the server 50 includes a communication unit 51, a management unit 52, and a control unit 53.

The communication unit 51 communicates with the network device 100 via the network described above. The communication unit 51 transmits and receives various notifications or information to and from the network device 100, as illustrated in FIGS. 6 and 7, which will be described later.

The management unit 52 manages the SIM profile. The SIM profile includes, for example, an IMSI required for connecting the UE 200 to the mobile communication network.

The control unit 53 controls the server 50. The control unit 53 controls, for example, the transmission and reception of notifications or information by the communication unit 51, and the management of the SIM profile by the management unit 52.

### (2.3) Functional Block Configuration of Terminal

As illustrated in FIG. 4, the UE 200 includes a communication unit 210, a SIM 220, an interface 230, and a control unit 240.

The communication unit 210 communicates with the network device 100 via the network described above. As illustrated in FIGS. 6 and 7, which will be described below, the communication unit 210 transmits and receives various notifications or information to and from the network device 100.

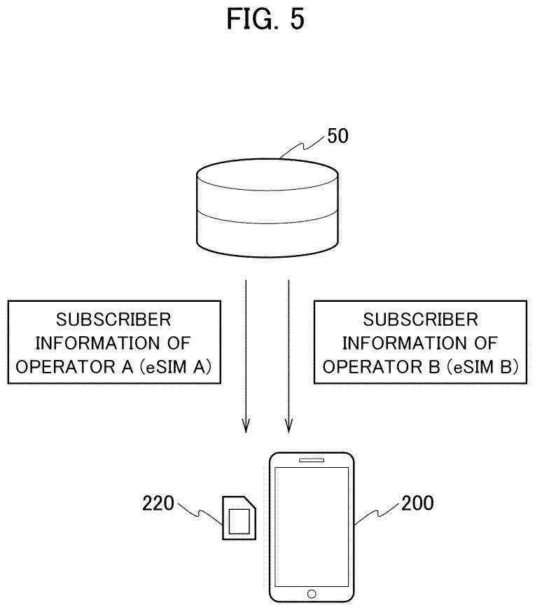

The SIM 220 is a module in which a SIM profile is written. As described above, the SIM 220 is not limited to a card-type IC such as an eUICC, but will be described as an eUICC. As illustrated in FIG. 5, a SIM profile (eSIM A and eSIM B in the drawing) including subscriber information of multiple telecommunications carriers may be written in the SIM 220. FIG. 5 does not illustrate the issuance of a SIM profile in the network device 100, but rather the issuance of a general SIM profile, that is, the issuance of a SIM profile based on an opening request from the UE 200.

The SIM 220 installs a SIM profile on itself (see FIG. 6). The SIM 220 has the same token verification function as the verification unit 130 described above (see FIG. 7). That is, the SIM 220 outputs an authentication token based on the authentication logic and the encryption key obtained in advance from an eUICC operator. Specifically, the authentication token is output from the encryption key based on the authentication logic. The output authentication token is transmitted to the network device 100 from the communication unit 210. Here, when random numbers are used in the authentication logic, an output of the authentication token may be interpreted as outputting the authentication token from the encryption key and random numbers.

Further, as with the verification unit 130, the SIM 220 confirms whether the authentication token output from the verification unit 130 is the same as the authentication token output from itself. Alternatively, the SIM 220 confirms whether the authentication token transmitted from the communication unit 110 and output from the verification unit 130 is the same as the authentication token output from itself. The authentication token output from itself in this context may be interpreted as a calculation result different from the authentication token transmitted to the verification unit 130 among multiple calculation results output from the SIM 220 based on the authentication logic. In other words, among the calculation results output from the SIM 220, the calculation result transmitted to the verification unit 130 may be different from the same calculation result as the one received from the UE 200.

Further, when the SIM 220 confirms that the authentication token output from the verification unit 130 is the same as the authentication token output from itself, the SIM 220 shifts the issuance status of the SIM profile to “not issued”. The SIM 220 shifts the issuance status of the SIM profile to “issued” after the issuance of the SIM profile by the issuing unit 120, more specifically, after receiving a factory issuance completion notification.

The interface 230 includes an input interface such as a touch panel.

The control unit 240 controls the UE 200. The control unit 240 controls, for example, the transmission and reception of notifications or information to and from the communication unit 210, the installation of the SIM profile, the output of the authentication token, the verification of the authentication token output from the verification unit 130, and the shift (transition) of the issuance status of the SIM profile by the SIM 220.

The control unit 240, instead of the SIM 220, may perform the installation of the SIM profile, the output of the authentication token, the verification of the authentication token output from the verification unit 130, and the transition of the issuance status of the SIM profile described above. That is, the SIM 220 includes a hardware configuration in which the SIM profile is written, and may be interpreted as not performing the installation of the SIM profile, the output of the authentication token, the verification of the authentication token output from the verification unit 130, and the transition of the issuance status of the SIM profile described above. In this case, the “module” described in the claims may be interpreted as a module including not only the SIM 220 but also the control unit 240.

### (3) Issuing Method

### (3.1) Problem

A SIM profile to be written in an eSIM is issued at a factory manufacturing a terminal (hereinafter, also referred to as a terminal operator). Specifically, a SIM profile such as subscriber information is acquired via a Subscription Manager (SM) server in a network device of the terminal operator, and the acquired SIM profile is written in the eSIM mounted to the terminal. At this point, an issuance status of the SIM profile issued by the terminal operator is shifted to “issued.”

However, from the viewpoint of security, the SIM profile whose issuance status is shifted to “issued” cannot be reissued in a network device of the terminal operator. Therefore, there is a problem in that the SIM profile cannot be reissued even if the terminal is returned to the terminal operator due to a failure or the like.

### (3.2) Operation Example

### (3.2.1) SIM Profile Issuance Procedure

A SIM profile issuance procedure at the time of shipment from the factory will be described with reference to FIG. 6. First, the server 50 notifies the network device 100 of the SIM profile (terminal purchase request in the drawing) based on the SIM profile acquisition request from the terminal operator (network device 100). Next, the network device 100 issues the SIM profile to the SIM 220 via the UE 200 (profile issuance in the drawing). In response to this, the SIM 220 installs the SIM profile on itself (profile installation in the drawing).

Next, the SIM 220 notifies the network device 100 that the SIM profile has been installed via the UE 200 (result notification in the drawing). In response, the network device 100 notifies the SIM 220 of the completion of SIM profile issuance via the UE 200 (factory issuance completion in the drawing). At this point, the SIM 220 shifts the issuance status of the SIM profile from “not issued” to “issued” (shift to shipment status in the drawing). Thereafter, the issuance status of the SIM profile cannot be returned to “not issued” by simple operation.

Finally, the SIM 220 notifies the network device 100 via the UE 200 that the issuance status of the SIM profile has been shifted to “issued”. Similarly, the network device 100 notifies the server 50 that the issuance status of the SIM profile has been shifted to “issued” (completion notification in the drawing).

### (3.2.2) Sim Profile Reissuance Procedure

The SIM profile reissuance procedure of the embodiment will be described with reference to FIG. 7. First, to enable the reissuance procedure, the terminal operator (network device 100) and the eUICC (SIM 220) share authentication logic and an encryption key to enable the status transition of the issuance status of the SIM profile (step S11). Specifically, the authentication logic and the encryption key are sold from an eUICC operator to the terminal operator (network device 100) and set to the eUICC (SIM 220). Thereafter, as described above, the SIM profile is issued to the SIM 220, and the issuance status of the SIM profile is shifted to “issued” (step S12).

After that, the UE 200 is returned to the terminal operator (network device 100) due to a failure or the like, and reissuance procedure of the SIM profile is performed. First, the network device 100 requests the SIM 220 to perform status transition of the issuance status. The SIM 220 outputs an authentication token from the encryption key based on the authentication logic shared with the network device 100 in step S11 (step S13). Here, the authentication token is output from an encryption key and random numbers.

Next, the SIM 220 transmits the output authentication token and the random numbers to the network device 100. The network device 100 outputs an authentication token from the encryption key based on the authentication logic shared with the SIM 220 in step S11, and verifies whether it is the same as the authentication token output from the SIM 220 (step S14).

Subsequently, the network device 100 transmits the output authentication token to the SIM 220. The SIM 220 confirms whether the authentication token output from itself and the authentication token output from the network device 100 are the same (step S15). The SIM 220, if the authentication token output from itself and the authentication token output from the network device 100 are the same, shifts the issuance status of the SIM profile from “issued” to “not issued” (step S16).

Thus, the network device 100 can reissue the SIM profile to the SIM 220 in the same manner as in step S12 (step S17).

### (4) Operation and Effect

In the issuing method of the embodiment described above, the issuance status of the SIM 220 can be securely shifted to the state before factory issuance by performing mutual authentication between the network device 100 and the SIM 220. Thus, even if the UE 200 is returned to the terminal operator (network device 100) due to a failure or the like, the SIM profile can be reissued securely and easily.

In the issuing method of the embodiment described above, the authentication logic and encryption key for mutual authentication between the network device 100 and the SIM 220 can be shared in advance, so that the SIM profile can be issued smoothly.

In the issuing method of the embodiment described above, the SIM profile can be issued via the server 50, so that the SIM profile can be issued securely.

In the issuing method of the embodiment described above, a common key is used as the encryption key, so that a processing burden related to mutual authentication between the network device 100 and the SIM 220 can be reduced. In particular, the issuing method of the embodiment described above is effective when a number of UE 200s are returned and the SIM profile needs to be reissued.

### (5) Other Embodiments

The contents of the present invention have been described in accordance with the embodiments described above. However, it is apparent to those skilled in the art that the present invention is not limited to these descriptions, and that various modifications and improvements are possible.

In the disclosure described above, the sharing step of the authentication logic and the encryption key is performed before the SIM 220 outputs the authentication token, but without limitation thereto. For example, it is possible to pass the authentication logic and the encryption key only to the SIM 220, and then to pass the authentication logic and the encryption key to the network device 100 after the SIM 220 has output the authentication token.

In the above disclosure, when the UE 200 is returned, the SIM profile installed in the SIM 220 may be deleted, before the SIM profile is reissued. This deletion step may be inserted between steps S15 and S16 in FIG. 7, for example.

The operation examples described above may be combined and applied in a complex manner as long as there is no contradiction.

In the above disclosure, terms such as configure, activate, update, indicate, enable, specify, and select may be read interchangeably. Similarly, terms such as link, associate, correspond, and map may be read interchangeably, and terms such as allocate, assign, monitor, and map may be read interchangeably.

In addition, terms such as specific, dedicated, UE-specific, and UE-dedicated may be read interchangeably. Similarly, terms such as common, shared, group-common, UE-common, and UE-shared may be read interchangeably.

The block diagram (FIG. 2, FIG. 3, FIG. 4) that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but the functions are by no means limited to these. For example, a functional block (component) to implement a function of transmission may be referred to as a “transmitting section (transmitting unit),” a “transmitter”. The method for implementing each component is not particularly limited as described above.

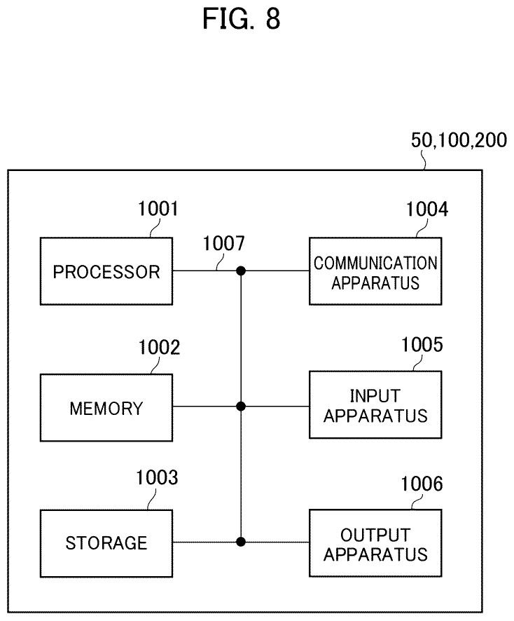

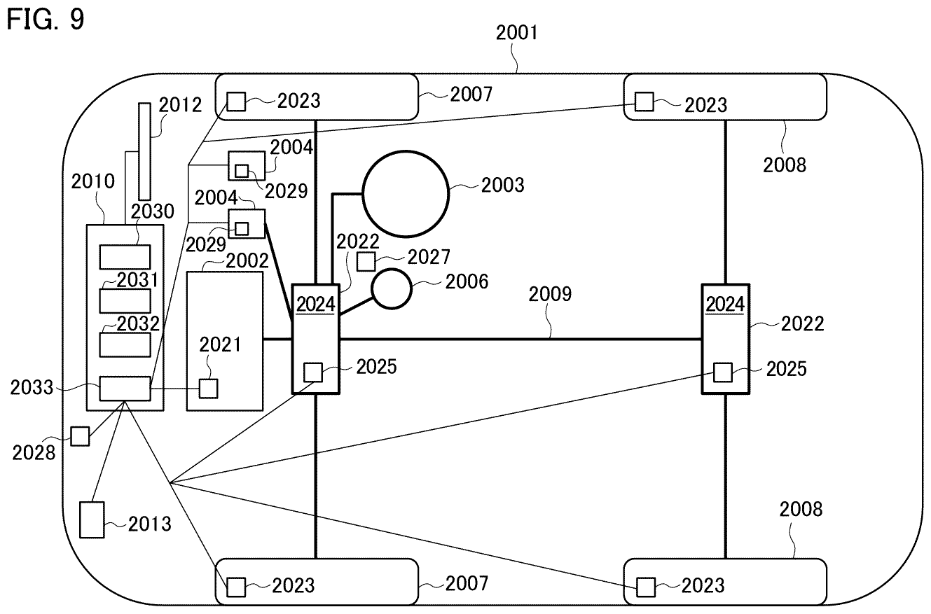

Furthermore, the above-described network device 100, server 50 and UE 200 (the apparatus) may function as a computer that executes the processes of the issuing method and the radio communication method of the present disclosure. FIG. 8 is a diagram to show an example of a hardware structure of the apparatus. As shown in FIG. 9, the apparatus may each be formed as a computer apparatus that includes a processor 1001, a memory 1002, a storage 1003, a communication apparatus 1004, an input apparatus 1005, an output apparatus 1006, a bus 1007, and so on.

Note that in the following description, the word such as an apparatus can be read as a circuit, a device, a section, a unit, and so on. The hardware structure of the apparatus may be configured to include one or more of apparatuses shown in the drawings, or may be configured not to include part of apparatuses.

Each function block (FIG. 2, FIG. 3, FIG. 4) of the apparatus is implemented by one of hardware elements or the combination of the hardware elements in the computer apparatus.

Each function of the apparatus is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. The above-described various processes may be performed by a single processor 1001, or may be performed by two or more processors 1001 simultaneously or sequentially. The processor 1001 may be implemented by one or more chips. It should be noted that the program may be transmitted from a network via a telecommunication line.

The memory 1002 is a computer-readable recording medium, and may be constituted with, for example, at least one of a Read Only Memory (ROM), an Erasable Programmable ROM (EPROM), an Electrically Erasable Programmable ROM (EEPROM), a Random Access Memory (RAM), and so on. The memory 1002 may be referred to as a “register,” a “cache,” a “main memory (primary storage apparatus)” and so on. The memory 1002 can store executable programs (program codes), software modules, and the like for implementing the method according to one embodiment of the present disclosure.

The storage 1003 is a computer-readable recording medium, and may be constituted with, for example, at least one of a compact disc (Compact Disc ROM (CD-ROM) and so on), a hard disk drive, a flexible disk, a magneto-optical disk (for example, a compact disc, a digital versatile disc, a Blu-ray (registered trademark) disk), a smart card, a flash memory device (for example, a card, a stick, and a key drive), a floppy (registered trademark) disk, a magnetic stripe, and so on. The storage 1003 may be referred to as “auxiliary storage apparatus.” The above recording medium may be a database including at least one of the memory 1002 and the storage 1003, a server, or any other appropriate medium.

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on.

The communication apparatus 1004 may be configured to include a high frequency switch, a duplexer, a filter, a frequency synthesizer, and so on in order to realize, for example, at least one of frequency division duplex (FDD) and time division duplex (TDD).

The input apparatus 1005 is an input device that receives input from the outside (for example, a keyboard, a mouse, a microphone, a switch, a button, a sensor, and so on). The output apparatus 1006 is an output device that performs output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, pieces of apparatus, including the processor 1001, the memory 1002, and others, are connected by a bus 1007 for communicating information. The bus 1007 may be formed with a single bus, or may be formed with buses that vary between pieces of apparatus.

Also, the apparatus may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

Notification of information is by no means limited to the aspects/embodiments described in the present disclosure, and other methods may be used as well. For example, notification of information may be implemented by using physical layer signaling (for example, downlink control information (DCI), uplink control information (UCI)), higher layer signaling (for example, RRC signaling, Medium Access Control (MAC) signaling), broadcast information (master information block (MIB), system information block (SIB)), and other signals or combinations of these. Also, RRC signaling may be referred to as an “RRC message,” and can be, for example, an RRC connection setup message, an RRC connection reconfiguration message, and so on.

The aspects/embodiments illustrated in the present disclosure may be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), New radio access (NX), W-CDMA (registered trademark), GSM (registered trademark), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate systems, next-generation systems that are enhanced based on these. A plurality of systems may be combined (for example, a combination of at least one of LTE and LTE-A, and 5G, and the like) for application.

The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

Specific operations which have been described in the present disclosure to be performed by a base station may, in some cases, be performed by an upper node thereof. In a network including one or a plurality of network nodes with the base station, it is clear that various operations that are performed to communicate with a terminal can be performed by the base station and other network nodes (for example, Mobility Management Entities (MMEs), Serving-Gateways (S-GWs), and so on may be possible, but these are not limiting) other than the base station, or combinations of these. According to the above, a case is described in which there is a single network node other than the base station. However, a combination of multiple other network nodes may be considered (e.g., MME and S-GW).

The information or signals may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A determination may be realized by a value (0 or 1) represented by one bit, by a boolean value (true or false), or by comparison of numerical values (e.g., comparison with a predetermined value).

Each aspect/embodiment described in the present disclosure may be used independently, may be used in combination, or may be used by switching according to operations. Further, notification of predetermined information (e.g., notification of “X”) is not limited to an explicit notification, and may be performed by an implicit notification (e.g., by not performing notification of the predetermined information).

Software should be broadly interpreted to mean, regardless of whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) and wireless technologies (infrared, microwave, etc.), at least one of these wired line technologies or wireless technologies is included within the definition of the transmission medium.

Information, a signal, or the like, described in the present disclosure may be represented by using any one of various different technologies. For example, data, an instruction, a command, information, a signal, a bit, a symbol, a chip, or the like, referred to throughout the above description, may be represented by a voltage, an electric current, electromagnetic waves, magnetic fields, a magnetic particle, optical fields, a photon, or a combination thereof.

It should be noted that a term described in the present disclosure and/or a term required for understanding of the present disclosure may be replaced by a term having the same or similar meaning. For example, a channel and/or a symbol may be a signal (signaling). Further, a signal may be a message. Further, the component carrier (CC) may be referred to as a carrier frequency, cell, frequency carrier, or the like.

As used in the present disclosure, the terms “system” and “network” are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms such as a “base station (BS),” a “radio base station,” a “fixed station,” a “NodeB,” an “eNodeB (eNB),” a “gNodeB (gNB),” an “access point,” a “transmission point,” a “reception point,” a “transmission/reception point,” a “cell,” a “sector,” a “cell group,” a “carrier,” a “component carrier,” and so on can be used interchangeably. A base station may be referred to as the terms such as a “macro cell,” a “small cell,” a “femto cell,” a “pico cell,” and so on.

A base station can accommodate one or a plurality of (for example, three) cells (which may be referred to as sectors). When a base station accommodates a plurality of cells, the entire coverage area of the base station can be partitioned into multiple smaller areas, and each smaller area can provide communication services through base station subsystems (for example, indoor small base stations (Remote Radio Heads (RRHs))).

The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases by the skilled person in the art.

At least one of a base station and a mobile station may be referred to as a “transmitting apparatus,” a “receiving apparatus,” a “communication apparatus,” and so on. Note that at least one of a base station and a mobile station may be a device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IOT) device such as a sensor.

Furthermore, a base station in the present disclosure may be interpreted as a mobile station (user terminal, hereinafter the same). For example, each aspect/embodiment of the present disclosure may be applied to the structure that replaces a communication between a base station and a mobile station with a communication between a plurality of mobile stations (for example, which may be referred to as “Device-to-Device (D2D),” “Vehicle-to-Everything (V2X),” and the like). In this case, the mobile station may have the functions of the base station described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, a mobile station in the present disclosure may be interpreted as a base station. In this case, the base station may have the functions of the mobile station described above.

A radio frame may be constituted of one or a plurality of frames in the time domain. Each of one or a plurality of frames may be referred to as a “subframe” in the time domain.

Furthermore, a subframe may be constituted of one or a plurality of slots in the time domain. A subframe may be a fixed time length (for example, 1 ms) independent of numerology.

Numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of the number of symbols less than a slot. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms.

For example, one subframe may be referred to as a “TTI,” a plurality of consecutive subframes may be referred to as a “TTI,” or one slot or one mini-slot may be referred to as a “TTI.” In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot,” a “mini-slot,” or the like, instead of a “subframe.”

Here, a TTI refers to the minimum time unit of scheduling in radio communication, for example. For example, in LTE systems, a base station performs, for user terminals, scheduling of allocating radio resources (such as a frequency bandwidth and transmit power available for each user terminal) in TTI units. Note that the definition of the TTI is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot,” or the like. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, or the like) may be interpreted as a TTI having a time length exceeding 1 ms, and a short TTI (for example, a shortened TTI or the like) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

An RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),”a “PRB pair,” an “RB pair” and so on.

Furthermore, a resource block may be constituted of one or a plurality of resource elements (REs). For example, one RE may be a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of one or more wires, cables, and printed electrical connections and, as a number of non-limiting and non-inclusive examples, electromagnetic energy having wavelengths in the radio frequency region, the microwave region, and the light (both visible and invisible) region.

A reference signal may be abbreviated as an “RS,” and may be referred to as a “pilot”, depending on which standard is applied.

The phrase “based on” as used in the present disclosure does not mean “based only on”, unless otherwise specified. In other words, the phrase “based on” means both “based only on” and “based at least on”.

“Means” included in the configuration of each of the above apparatuses may be replaced by “parts”, “circuits”, “devices”, etc.

Reference to elements with designations such as “first,” “second,” and so on used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

In the case where the terms “include”, “including” and variations thereof are used in the present disclosure, these terms are intended to be comprehensive in the same way as the term “comprising”. Further, the term “or” used in the present disclosure is not intended to be an “exclusive or”.

In the present disclosure, in the case where an article is added by translation, for example “a”, “an”, and “the”, the disclosure may include that the noun following these articles is plural.

As used in the present disclosure, the term “determining” may encompasses a wide variety of actions. For example, “determining” may be regarded as determining to have performed judging, calculating, computing, processing, deriving, investigating, looking up (looking up, search, inquiry) (e.g., looking up in a table, a database or another data structure), ascertaining and the like. Also, “determining” may be regarded as determining to have performed receiving (e.g., receiving information), transmitting (e.g., transmitting information), inputting, outputting, accessing (e.g., accessing data in a memory) and the like. Also, “determining” may be regarded as determining to have performed resolving, selecting, choosing, establishing, comparing and the like. That is, “determining” may be regarded as determining to have performed some action. Moreover, “determining” may be read as “assuming”, “expecting”, “considering”, and the like.

In this disclosure, the term “A and B are different” may mean “A and B are different from each other.” It should be noted that the term “A and B are different” may mean “A and B are different from C.” Terms such as “separated” or “combined” may be interpreted in the same way as the “different”.

FIG. 9 shows an example of a configuration of a vehicle 2001. As shown in FIG. 9, the vehicle 2001 includes a drive unit 2002, a steering unit 2003, an accelerator pedal 2004, a brake pedal 2005, a shift lever 2006, left and right front wheels 2007, left and right rear wheels 2008, an axle 2009, an electronic control unit 2010, various sensors 2021-2029, an information service unit 2012, and a communication module 2013.

The drive unit 2002 may include, for example, an engine, a motor, and a hybrid of an engine and a motor.

The steering unit 2003 includes at least a steering wheel and is configured to steer at least one of the front wheel or the rear wheel, based on the operation of the steering wheel operated by the user.

The electronic control unit 2010 includes a microprocessor 2031, a memory (ROM, RAM) 2032, and a communication port (IO port) 2033. The electronic control unit 2010 receives signals from the various sensors 2021-29 provided in the vehicle. The electronic control unit 2010 may be referred to as an ECU (Electronic Control Unit).

The signals from the various sensors 2021 to 2028 include a current signal from a current sensor 2021 which senses the current of the motor, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, an accelerator pedal stepped-on amount signal acquired by an accelerator pedal sensor 2029, a brake pedal stepped-on amount signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like.

The information service unit 2012 includes various devices for providing (outputting) various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 2001 by using information obtained from the external device through the communication module 2013 or the like.

A driving support system unit 2030 includes: various devices for providing functions of preventing accidents and reducing driver's operating loads such as a millimeter wave radar, a LiDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, an AI processor; and one or more ECUs controlling these devices. In addition, the driving support system unit 2030 transmits and receives various types of information via the communication module 2013 to realize a driving support function or an autonomous driving function.

The communication module 2013 may communicate with the microprocessor 2031 and components of the vehicle 2001 via a communication port. For example, the communication module 2013 transmits and receives data via a communication port 2033, to and from the drive unit 2002, the steering unit 2003, the accelerator pedal 2004, the brake pedal 2005, the shift lever 2006, the left and right front wheels 2007, the left and right rear wheels 2008, the axle 2009, the microprocessor 2031 and the memory (ROM, RAM) 2032 in the electronic control unit 2010, and the sensors 2021 to 2028 provided in the vehicle 2001.

The communication module 2013 is a communication device that can be controlled by the microprocessor 2031 of the electronic control unit 2010 and that is capable of communicating with external devices. For example, various kinds of information are transmitted to and received from external devices through radio communication. The communication module 2013 may be internal to or external to the electronic control unit 2010. The external devices may include, for example, a base station, a mobile station, or the like.

The communication module 2013 transmits a current signal from a current sensor, which is input to the electronic control unit 2010, to external devices through radio communication. Also, the communication module 2013 transmits to external devices through radio communication, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, an accelerator pedal stepped-on amount signal acquired by an accelerator pedal sensor 2029, a brake pedal stepped-on amount signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like, which are input to the electronic control unit 2010.

The communication module 2013 receives various types of information (traffic information, signal information, inter-vehicle information, etc.) transmitted from the external devices and displays the received information on the information service unit 2012 provided in the vehicle 2001. In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the left and right front wheels 2007, the left and right rear wheels 2008, the axle 2009, the sensors 2021-2028, etc., mounted in the vehicle 2001.

As described above, the present disclosure has been described in detail. It is apparent to a person skilled in the art that the present disclosure is not limited to one or more embodiments described in the present disclosure. The present disclosure can be implemented as modifications and variations without departing from the subject matter and the scope of the present disclosure defined by the descriptions of claims. Therefore, the descriptions of the present disclosure are for illustrative purposes only, and are not intended to be any limitations to the present disclosure.

### Supplementary Notes

The above disclosure may be expressed as follows.

A first feature is an issuing method to issue a profile for connecting a terminal to a mobile communication network to be written in a module mounted to the terminal in a network device of a terminal operator manufacturing the terminal, comprising: a first output step in which the module outputs a first authentication token from an encryption key based on authentication logic; a second output step in which the network device outputs a second authentication token from the encryption key based on the authentication logic; a confirmation step in which the module confirms whether the first authentication token and the second authentication token are the same; and an issuing step in which the network device issues the profile when it is confirmed that the first authentication token and the second authentication token are the same.

A second feature is the issuing method according to the first feature, further comprising a step of sharing in which the network device and the module share the authentication logic and the encryption key before the first output step.

A third feature is the issuing method according to the first feature or the second feature, wherein the issuing step includes a step of issuing the profile via a server.

A fourth feature is the issuing method according to any one of the first feature to the third feature, wherein the encryption key is a common key.

A fifth feature is an issuing system to issue a profile for connecting a terminal to a mobile communication network to be written in a module mounted to the terminal, comprising: a network device of a terminal operator manufacturing the terminal; and the module mounted to the terminal; wherein the module outputs a first authentication token from an encryption key based on authentication logic; the network device outputs a second authentication token from the encryption key based on the authentication logic; the module confirms whether the first authentication token and the second authentication token are the same; and the network device issues the profile when it is confirmed that that the first authentication token and the second authentication token are the same.

### REFERENCE SIGNS LIST

50 Server
51 Communication unit
52 Management unit
53 Control unit
100 Terminal Operator
110 Communication unit
120 Issuing unit
130 Verification unit
140 Control unit
200 UE
210 Communication unit
220 SIM
230 Interface
240 Control unit
1001 Processor
1002 Storage
1003 Storage
1004 Communication apparatus
1005 Input apparatus
1006 Output apparatus
1007 Bus
2001 Vehicle
2002 Drive unit
2003 Steering unit
2004 Accelerator pedal
2005 Brake pedal
2006 Shift lever
2007 Left and right front wheels
2008 Left and right rear wheels
2009 Axle
2010 Electronic control unit
2012 Information service unit
2013 Communication module
2021 Current sensor
2022 Rotational speed sensor
2023 Pneumatic sensor
2024 Vehicle speed sensor
2025 Acceleration sensor
2026 Brake pedal sensor
2027 Shift lever sensor
2028 Object detection sensor
2029 Accelerator pedal sensor
2030 Driver support system unit
2031 Microprocessor
2032 Memory (ROM, RAM)
2033 Communication port

1. An issuing method to issue a profile for connecting a terminal to a mobile communication network to be written in a module mounted to the terminal in a network device of a terminal operator manufacturing the terminal, comprising:
a first output step in which the module outputs a first authentication token from an encryption key based on authentication logic;
a second output step in which the network device outputs a second authentication token from the encryption key based on the authentication logic;
a confirmation step in which the module confirms whether the first authentication token and the second authentication token are the same; and
an issuing step in which the network device issues the profile when it is confirmed that the first authentication token and the second authentication token are the same.

2. The issuing method according to claim 1, further comprising a step of sharing in which the network device and the module share the authentication logic and the encryption key before the first output step.

3. The issuing method according to claim 1, wherein the issuing step includes a step of issuing the profile via a server.

4. The issuing method according to claim 1, wherein the encryption key is a common key.

5. An issuing system to issue a profile for connecting a terminal to a mobile communication network to be written in a module mounted to the terminal, comprising:
a network device of a terminal operator manufacturing the terminal; and
the module mounted to the terminal; wherein
the module outputs a first authentication token from an encryption key based on authentication logic;
the network device outputs a second authentication token from the encryption key based on the authentication logic;
the module confirms whether the first authentication token and the second authentication token are the same; and
the network device issues the profile when it is confirmed that that the first authentication token and the second authentication token are the same.
